(19) United States
(12) Patent Application Publication
(10) Pub. No.: US 2009/0267535 A1
(43) Pub. Date: Oct. 29, 2009

(54) AC POWER SOURCE APPARATUS

(75) Inventor: Toru ASHIKAGA, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/423,916

(22) Filed: Apr. 15, 2009

(30) Foreign Application Priority Data
Apr. 23, 2008 (JP) 2008-112889

(51) Int. Cl. H05B 37/02

(52) U.S. Cl. 315/294

(57) ABSTRACT

An AC power source apparatus includes an inverter 1c generating a first AC voltage for a load from a DC voltage of a first DC power source through a first switch, an inverter 1d generating a second AC voltage for the load from a DC voltage of the first or second DC power source through a second switch in which a phase difference thereof being about 180 degrees to the first AC voltage, a controller to control an ON duty of the first switch, set a phase difference for the second switch with respect to the first switch, and control an ON duty of the second switch, and a phase difference controller to control the phase difference in such a way as to equalize output voltage or output current of the output power of the inverters.

### BACKGROUND OF THE INVENTION

1. Field of the Invention

The present invention relates to an AC (alternating current) power source apparatus for converting a DC (direct current) voltage into an AC voltage through a transformer and supplying the AC voltage to a load, and particularly, to a technique of supplying the AC voltage to a discharge lamp serving as the load and lighting the discharge lamp.

2. Description of the Related Art

An AC power source apparatus has a transformer to convert a DC voltage into an AC voltage that drives a load. An example of the AC power source apparatus for driving a load is a discharge lamp lighting apparatus that applies an AC voltage to the load, i.e., a cold cathode fluorescent lamp (CCFL) and lights the CCFL thereby.

To light the CCFL, the AC power source apparatus should apply thereto a voltage of several hundreds to one thousand and several hundreds of voltages at a frequency of several tens of kilohertz. Besides the CCFL, there is a fluorescent lamp called external electrode fluorescent lamp (EEFL). The CCFL and EEFL have different electrode structures. Except the electrodes, the CCFL and EEFL are substantially the same including a light emitting principle. Accordingly, the AC power source apparatus for lighting the CCFL resembles that for lighting the CCFL in principle. The following explanation will be made in connection with the CCFL (“CCFL” will be referred to as “discharge lamp”).

As the discharge lamp elongates, a voltage necessary for lighting the discharge lamp increases, and therefore, a transformer in the AC power source apparatus for lighting the discharge lamp needs to output a higher voltage. FIG. 1 illustrates an AC power source apparatus for lighting a long discharge lamp according to a related art. The related art of FIG. 1 employs standard inverters and a controller. The inverters 1e and 1f contain transformers T1 and T2, respectively, and the controller 100 drives the transformers T1 and T2 in opposite phases, to halve the output voltage of each transformer.

There are various operation sequences applicable to the AC power source apparatus of FIG. 1. FIG. 2 is a timing chart illustrating a current resonant operating sequence applied to the apparatus of FIG. 1.

In FIG. 1, the controller 100 controls the ON duty of each of high-side switches Q1 and Q3 (Q5 and Q7), to control output voltage, output current, output power, input power, and the like. Low-side switches Q2 and Q4 (Q6 and Q8) are for resonant operation and for controlling a regenerative current. The object to be controlled may be chosen from among the output voltage, output current, output power, input power, and the like according to the use, characteristics, or specifications of the AC power source apparatus.

In the example of FIG. 1, the AC power source apparatus controls an output current and the switches Q1 to Q8 in the apparatus are n-type MOSFETs. A current detector 17 detects a current on the secondary side of the transformer T1. Based on the detected current, the controller 100 turns on/off the switches Q1 to Q8. In this case, it is preferable to detect a current passing through a load 7, i.e., a CCFL. The load 7, however, is driven by high voltage and it is difficult to detect a current passing through such a high-voltage object. Accordingly, a current on the secondary side of the transformer T2 is detected as an approximate value of the current passed to the load 7. Instead, it is possible to obtained an average of currents detected on the secondary sides of the transformers T1 and T2.

In the controller 100, an error amplifier 106 amplifies an error voltage between a voltage representative of the current detected by the current detector 17 and a reference voltage E2 and outputs the amplified error voltage to a non-inverting input terminal (depicted by “+”) of each of comparators 102 and 103.

A triangular signal generator 104 generates a triangular signal and outputs the same to an inverting input terminal (depicted by “−”) of the comparator 102. An inverting level shifter 105 inverts and level-shifts the triangular signal and outputs the inverted and level-shifted triangular signal to an inverting input terminal (depicted by “−”) of the comparator 103. The comparator 102 compares the triangular signal with the error voltage from the error voltage amplifier 106 and generates a first pulse signal. The comparator 103 compares the inverted and level-shifted triangular signal with the error voltage from the error voltage amplifier 106 and generates a second pulse signal.

Based on the first pulse signal from the comparator 102, a PWM signal generator 101 generates a drive signal for the switch Q1 (Q7) and a drive signal for the switch Q2 (Q8). Based on the second pulse signal from the comparator 103, the PWM signal generator 101 generates a drive signal for the switch Q3 (Q5) and a drive signal for the switch Q4 (Q6).

The related art of FIG. 1 is inexpensive because the single controller 100 controls the switches Q1 to Q8. The single error amplifier 106 generates drive signals for the switches Q1 to Q8, and therefore, drive signals for the switches Q1 and Q3 (Q5 and Q7) and drive signals for the switches Q2 and Q4 (Q6 and Q8) have substantially the same ON duty.

Due to this configuration, the related art is unable to separately control the ON duties of the switches Q1 and Q3. The switches Q1 to Q4 of the inverter 1e and the switches Q5 to Q8 of the inverter 1f receive control signals having the same ON duty and a phase difference of 180 degrees. If the transformers T1 and T2, reactors L1 and L2, capacitors C1 to C4, and the like arranged in the inverters 1e and 1f involve no parts variations or parasitic capacitance (Ca, Cb) variations, an output V1 from the inverter 1e will be equal to an output V2 from the inverter 1f.

The related art explained above is disclosed in, for example, Japanese Unexamined Patent Application Publication No. H08-162280.

### SUMMARY OF THE INVENTION

In practice, the parts and parasitic capacitance in the AC power source apparatus involve variations, and therefore, the output V1 from the inverter 1e disagrees with the output V2 from the inverter 1f. If the variations among the parts and parasitic capacitance are large, the difference between the inverter outputs V1 and V2 will be large.

If the inverter outputs V1 and V2 differ from each other, there will naturally be a difference in power loss between the inverters 1e and 1f. This will cause differences among parts temperatures between the inverters 1e and 1f, so that large temperature margins must be considered when designing the parts of the inverters 1e and 1f. This will increase the cost of the apparatus and deteriorate heat radiation efficiency of the parts.

In addition, to reduce a difference in output current between the inverters 1e and 1f, the related art should select the parts to be arranged in the inverters from among those having similar parts constants.

According to the present invention, provided is an AC power source apparatus capable of equalizing the output voltages and output currents of two inverters and supplying required power to a load, with the use of a single controller without specially managing parts constants.

A first aspect of the present invention provides an AC power source apparatus including a first AC power generator having a first switch unit and configured to generate a first AC voltage from a DC voltage of a first DC power source by way of an ON/OFF operation of the first switch unit and output the first AC voltage to a first end of a load; a second AC power generator having a second switch unit and configured to generate a second AC voltage from a DC voltage of one of the first DC power source and a second DC power source by way of an ON/OFF operation of the second switch unit and output the second AC voltage to a second end of the load, the second AC voltage having a phase difference of about 180 degrees with respect to the first AC voltage; a controller configured to control an ON duty of the first switch unit thereby controlling first AC power, set a phase difference for the ON/OFF operation of the second switch unit with respect to the ON/OFF operation of the first switch unit, and control an ON duty of the second switch unit thereby controlling second AC power; and a phase difference controller configured to control the phase difference set for the ON/OFF operation of the second switch unit so that output voltage or output current of the second AC power generator is equalized with that of the first AC power generator.

According to a second aspect of the present invention, the phase difference controller includes a first voltage detector configured to detect the first AC voltage; a second voltage detector configured to detect the second AC voltage; a voltage difference detector configured to detect a voltage difference between the detected first and second AC voltages; and a phase difference variable determiner configured to determine a phase difference variable according to the detected voltage difference. The controller is configured to control the phase difference set for the ON/OFF operation of the second switch unit according to the determined phase difference variable.

According to a third aspect of the present invention, the phase difference controller includes the phase difference controller includes a first current detector configured to detect a first AC current outputted to the first end of the load; a second current detector configured to detect a second AC current outputted to the second end of the load; a current difference detector configured to detect a current difference between the detected first and second AC currents; and a phase difference variable determiner configured to determine a phase difference variable according to the detected current difference. The controller is configured to control the phase difference set for the ON/OFF operation of the second switch unit according to the determined phase difference variable.

### BRIEF DESCRIPTION OF THE DRAWINGS

FIG. 1 is a circuit diagram illustrating an AC power source apparatus according to a related art employing standard inverters and a controller;

FIG. 2 is a timing chart illustrating operation of the AC power source apparatus of FIG. 1;

FIG. 3 is a circuit diagram illustrating an AC power source apparatus embodying a principle of the present invention;

FIG. 4 is a waveform diagram illustrating output voltages from two inverters arranged in the AC power source apparatus of FIG. 3, a phase difference between the two output voltages being changed around 180 degrees;

FIGS. 5A-5C illustrate waveform diagrams of output voltages from the two inverters arranged in the AC power source apparatus of FIG. 3, the output voltages being applied to ends of a load with a phase difference of 180 degrees (FIG. 5A) and phase differences of larger than 180 degrees (FIGS. 5B and 5C);

FIG. 6 is a graph illustrating a relationship between phase difference and output voltage difference, the phase difference being changed around 180 degrees and the output voltage difference being measured between the two inverters arranged in the AC power source apparatus of FIG. 3;

FIG. 7 is a circuit diagram illustrating an AC power source apparatus according to Embodiment 1 of the present invention;

FIG. 8 is a timing chart illustrating a phase difference controlling operation achieved by the AC power source apparatus according to Embodiment 1;

FIG. 9A illustrates functions of a triangular signal generator arranged in a controller of the AC power source apparatus according to Embodiment 1, the triangular signal generator generating a triangular signal having equal rise time and fall time;

FIG. 9B illustrates functions of a triangular signal generator arranged in a controller of the AC power source apparatus according to Embodiment 1, a triangular signal having a longer rise time than a fall time;

FIG. 9C illustrates functions of a triangular signal generator arranged in a controller of the AC power source apparatus according to Embodiment 1, a triangular signal having a longer fall time than a rise time;

FIG. 10 is a circuit diagram illustrating output voltage detectors, an output voltage difference detector, a phase difference variable determiner, and a controller in the AC power source apparatus according to Embodiment 1;

FIG. 11 is a timing chart illustrating a phase difference controlling operation achieved according to a modification of Embodiment 1 of the present invention;

FIG. 12 is a circuit diagram illustrating an AC power source apparatus according to Embodiment 2 of the present invention;

FIG. 13 is a circuit diagram illustrating a delay circuit arranged in the AC power source apparatus according to Embodiment 2;

FIG. 14 is a graph illustrating a relationship between signal voltage Vcont from a phase difference variable determiner and output voltage Vc from an operational amplifier in the delay circuit of FIG. 13;

FIG. 15 is a timing chart illustrating a clock signal and delayed signals in the delay circuit of FIG. 13;

FIG. 16 is a circuit diagram illustrating an AC power source apparatus according to Embodiment 3 of the present invention;

FIG. 17 is a circuit diagram illustrating output current detectors, an output current difference detector, a phase difference variable determiner, and a controller in the AC power source apparatus according to Embodiment 3; and

FIG. 18 is a circuit diagram illustrating an AC power source apparatus according to Embodiment 4 of the present invention.

### DESCRIPTION OF THE PREFERRED EMBODIMENT

AC power source apparatuses according to embodiments of the present invention will be explained in detail with reference to the drawings.

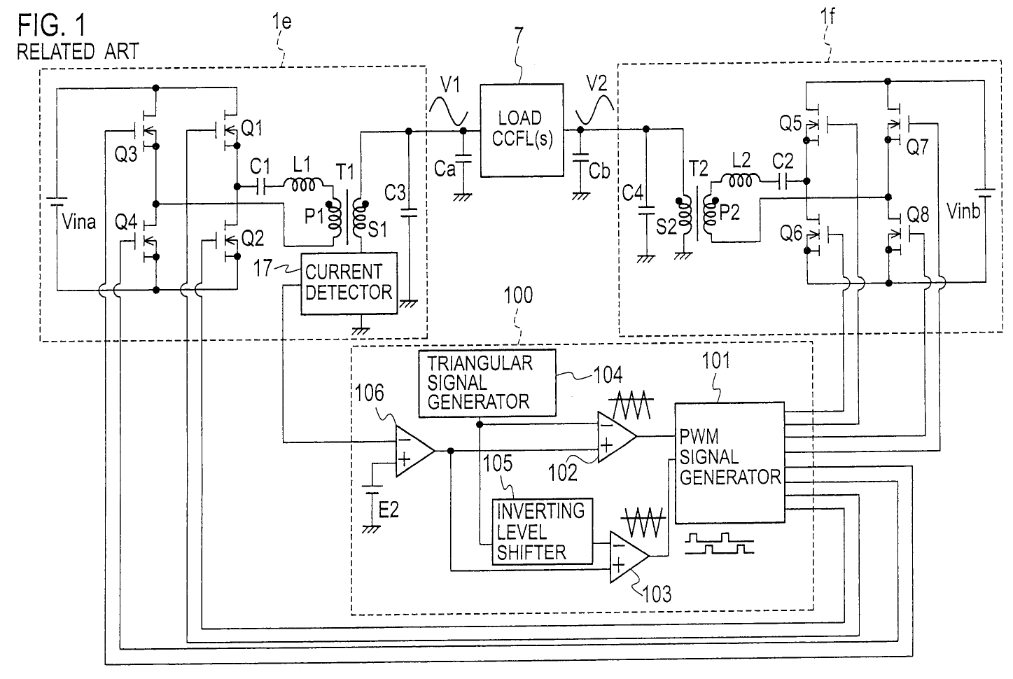

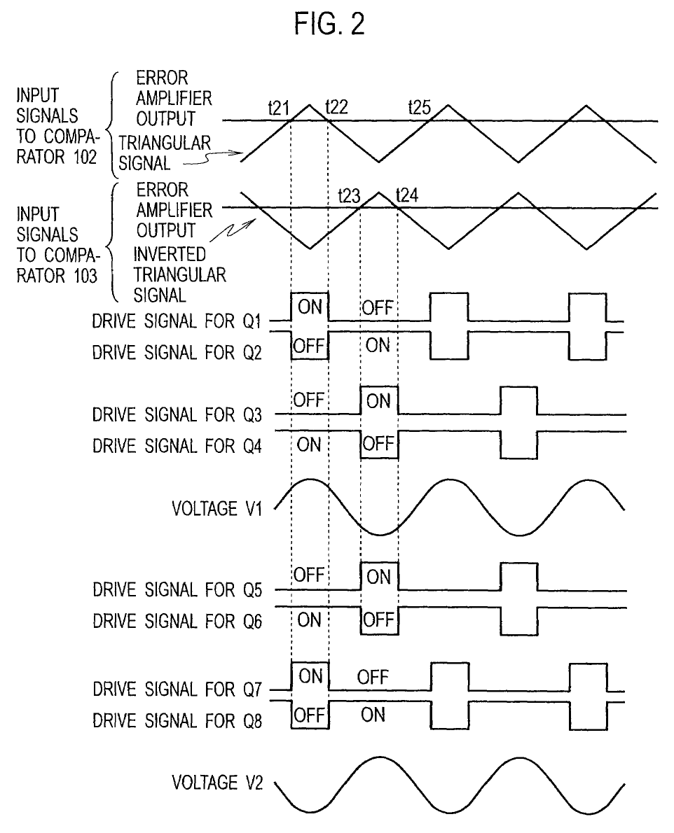

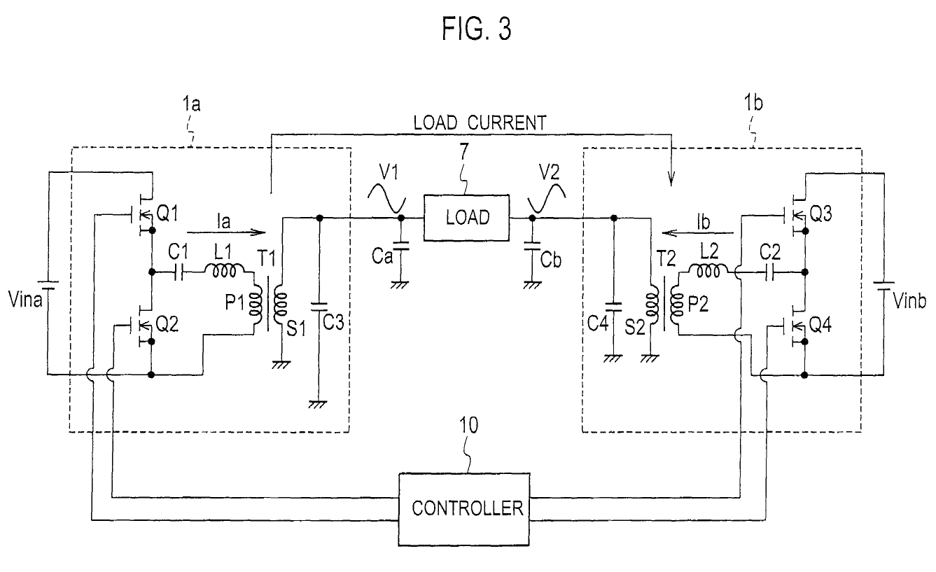

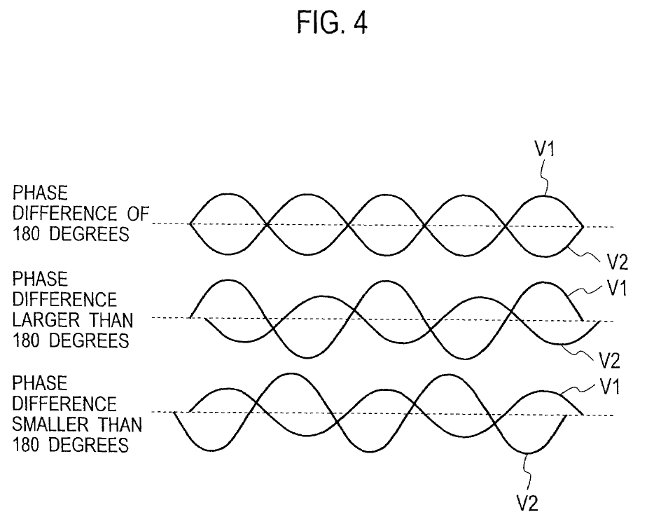

A principle of the present invention will be explained with reference to an AC power source apparatus illustrated in FIG. 3 and graphs illustrated in FIGS. 4 to 6. According to the related art of FIG. 1, the controller 100 that is single is incapable of separately controlling the ON duties of drive signals for the two inverters 1e and 1f, as is apparent from the operation sequence illustrated in FIG. 2. The related art should drive the two inverters 1e and 1f with drive signals having the same ON duty. If a voltage difference or a current difference occurs between the two inverters 1e and 1f, the related art is unable to reduce the differences. The present invention provides a technique of controlling the phases of drive signals to reduce such an output voltage or current difference between two inverters. The present invention is applicable to reduce not only a voltage difference but also a current difference.

A phase difference between drive signals for driving two inverters is generally set as 180 degrees. Slightly shifting the phase difference results in changing output voltages V1 and V2 of the two inverters as illustrated in FIG. 4, even with the same parts constants and the same ON duty for the drive signals.

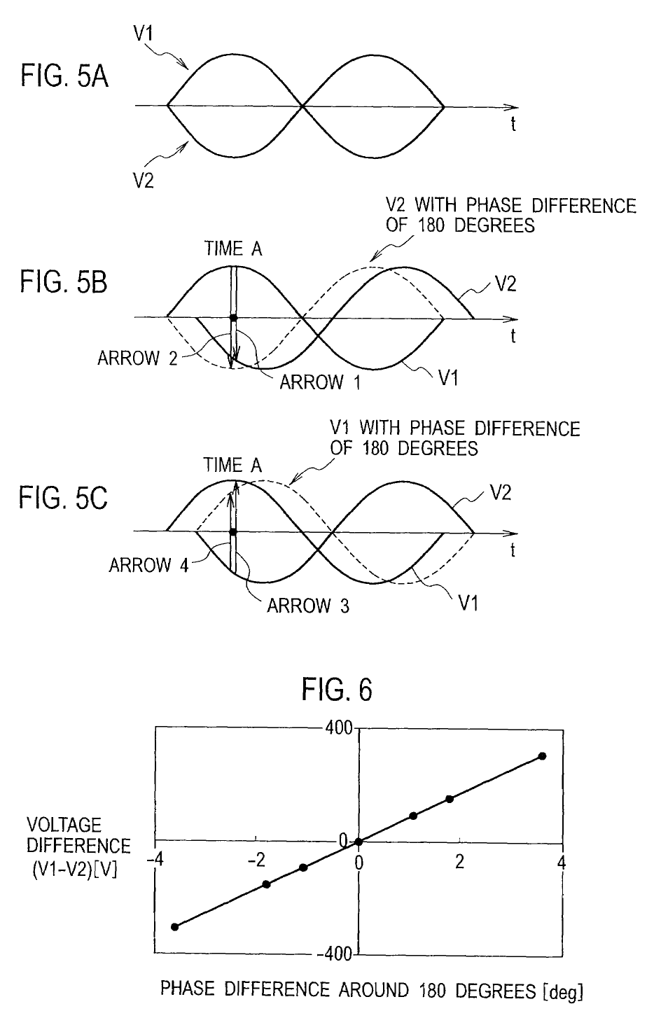

FIG. 5A illustrates waveforms provided by two inverters IN1 (corresponding to 1a of FIG. 3) and IN2 (corresponding to 1b of FIG. 3) having a phase difference of 180 degrees. Namely, an output voltage V2 from the inverter IN2 is delayed by just 180 degrees behind an output voltage V1 from the inverter IN1. FIG. 5B illustrates waveforms provided by the two inverters IN1 and IN2 having a phase difference larger than 180 degrees. In FIG. 5B, a dotted waveform is a waveform having a phase difference of 180 degrees. The output voltage V2 from the inverter IN2 is behind the output voltage V1 from the inverter IN1 by a phase difference larger than 180 degrees.

In FIG. 5B, the output voltage V1 from the inverter IN1 reaches a maximum at time A. At this time, a load current passes in the direction of an arrow illustrated in FIG. 3, a voltage of (V1−V2)[V] is applied to both ends of a load 7, a current of (V1−V2)/R)[A] passes through the load 7, where R is a resistance value of the load 7. A voltage across the load 7 viewed from a transformer T1 corresponds to the length of an arrow 1 illustrated in FIG. 5B. If the phase difference is just 180 degrees, the voltage across the load 7 corresponds to the length of an arrow 2 that is longer than the arrow 1. Namely, in this case, the voltage across the load 7 decreases and a current passing through the load 7 lessens. At time A, the inverter 1a is at the maximum ON duty to provide the maximum voltage (arrow 1) but a lower current passes through the load 7. Since the current flowing from the inverter 1a to the load 7 decreases, a current 1a passing through a reactor L1 and a capacitor C1 also decreases. As results, a voltage drop due to the reactor L1 and capacitor C1 becomes smaller, to increase a voltage applied to a primary winding P1 of the transformer T1, thereby increasing an output voltage from the inverter 1a.

FIG. 5C illustrates voltages viewed from a transformer T2. The inverter 1a outputs a maximum voltage at time A. At this time, a voltage across the load 7 corresponds to the length of an arrow 3. Naturally, the length of the arrow 3 is the same as that of the arrow 1. With a phase difference of 180 degrees, a voltage across the load 7 corresponds to the length of an arrow 4 that is shorter than the arrow 3. Namely, with a phase difference larger than 180 degrees, an output current from the inverter 1b increases at time A. As results, a current 1b passed to a reactor L2 and a capacitor C2 also increases, and therefore, a voltage drop due to the reactor L2 and capacitor C2 becomes larger. This results in decreasing a voltage applied to a primary winding P2 of the transformer T2 and lowering an output voltage from the inverter 1b.

In this way, a change in a phase difference from 180 degrees results in increasing an output voltage from one inverter and decreasing an output voltage from the other inverter, as illustrated in FIG. 4. If the output voltage V2 from the inverter 1b (IN2) has a phase difference greater than 180 degrees with respect to the output voltage V1 from the inverter 1a (IN1), the output voltage V2 will be smaller than the output voltage V1. If the output voltage V2 from the inverter 1b has a phase difference smaller than 180 degrees with respect to the output voltage V1 from the inverter 1a, the output voltage V2 will be higher than the output voltage V1.

This tendency is confirmable in a simulation result illustrated in FIG. 6. In FIG. 6, a phase difference of the inverter 1b with respect to the inverter 1a is changed by about ±4 degrees from +180 degrees and a voltage difference between the inverters 1a and 1b is measured each time. In FIG. 6, an ordinate represents the output voltage difference between the two inverters 1a and 1b. The simulation is carried out with no variations among parts constants and no change in power consumption by the load 7. When the phase difference is just 180 degrees, no difference is observed between the output voltages of the inverters 1a and 1b. As the phase difference increases or decreases from 180 degrees, a difference between the output voltages of the inverters 1a and 1b becomes larger. Namely, slightly changing the phase difference from 180 degrees may minimize a difference between the output voltages of the two inverters 1a and 1b without changing ON duty under an applicable control.

### Embodiment 1

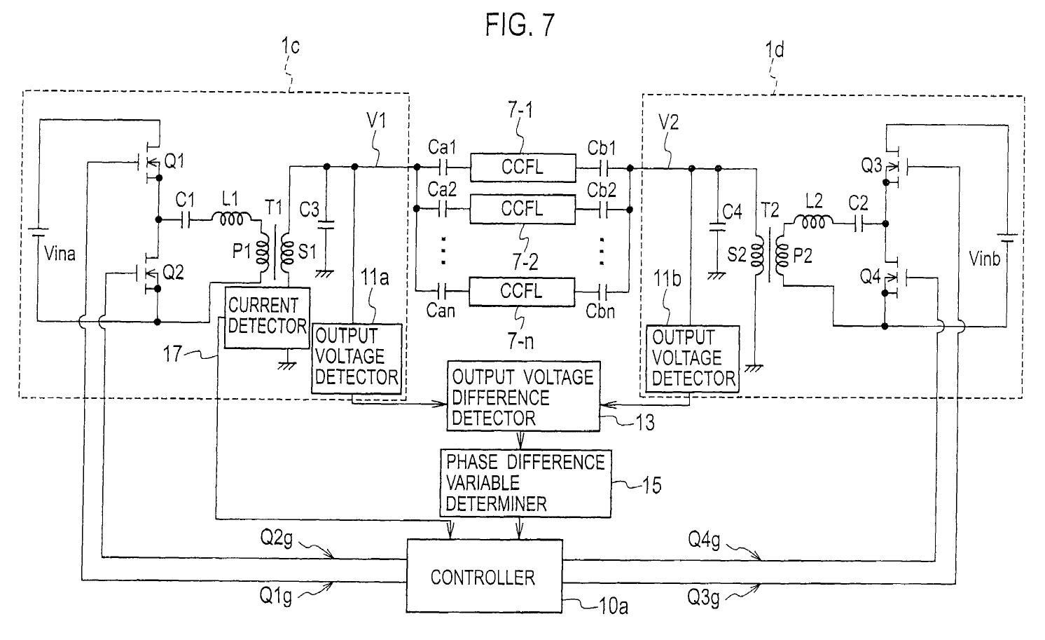

FIG. 7 is a circuit diagram illustrating an AC power source apparatus according to Embodiment 1 of the present invention. In embodiments mentioned below, an AC power source apparatus is used as a discharge lamp lighting apparatus that lights a discharge lamp acting as a load. The AC power source apparatus according to the present invention is applicable not only to discharge lamps but also to any other load.

In FIG. 7, inverters 1c and 1d are arranged on each side of discharge lamps 7-1 to 7-n acting as a load. The inverter 1c includes a first AC power generator that generates a first AC voltage from a DC voltage of a DC power source Vina by turning on/off switches Q1 and Q2 (first switch) and outputs the first AC voltage to first ends of the discharge lamps 7-1 to 7-n. The inverter 1d includes a second AC power generator that generates a second AC voltage from a DC voltage of a DC power source Vinb by turning on/off switches Q3 and Q4 (second switch) and outputs the second AC voltage to second ends of the discharge lamps 7-1 to 7-n.

In the first AC power generator, ends of the DC power source Vina are connected to a series circuit having the switches Q1 and Q2 those are, for example, MOSFETs. Connected between the drain and source of the switch Q2 is a series circuit including a capacitor C1, a reactor L1, and a primary winding P1 of a transformer T1. A secondary winding S1 of the transformer T1 and a current detector 17 form a series circuit that is connected in parallel with a capacitor C3. A connection point (non-grounded side) of the secondary winding S1 and capacitor C3 is connected to a common first end of ballast capacitors Ca1 to Can. Second ends of the ballast capacitors Ca1 to Can are connected to the first ends of the discharge lamps 7-1 to 7-n, respectively. The reactor L1 and capacitor C3 serve as filters to output an AC voltage to the capacitor C3.

In the second AC power generator, ends of the DC power source Vinb are connected to a series circuit having the switches Q3 and Q4 those are, for example, MOSFETs. Connected between the drain and source of the switch Q4 is a series circuit including a capacitor C2, a reactor L2, and a primary winding P2 of a transformer T2. A connection point (non-grounded side) of a secondary winding S2 of the transformer T2 and a capacitor C4 is connected to a common first end of ballast capacitors Cb1 to Cbn. Second ends of the ballast capacitors Cb1 to Cbn are connected to the second ends of the discharge lamps 7-1 to 7-n, respectively. The reactor L2 and capacitor C4 serve as filters to output an AC voltage to the capacitor C4.

A controller 10a provides gate signals Q1g and Q2g to complementarily turn on/off the switches Q1 and Q2 (first arm), as well as gate signals Q3g and Q4g to complementarily turn on/off the switches Q3 and Q4 (second arm) by setting a phase difference of about 180 degrees between the ON/OFF timing of the switches Q3 and Q4 and the ON/OFF timing of the switches Q1 and Q2. Although not illustrated, the controller 10a includes devices corresponding to the error amplifier 106, inverting level shifter 105, comparators 102 and 103, PWM signal generator 101, and triangular signal generator 104 as illustrated in FIG. 1.

The current detector 17 detects a secondary side current of the transformer T1 as an approximate value of a current passed to the load 7 (discharge lamps 7-1 to 7-n). According to the current detected by the current detector 17, the controller 10a controls the ON duties of the switches Q1 to Q4. The secondary side current of the transformer T1 is nearly equal to a current passing through the load 7, and therefore, controlling the ON duties of the switches Q1 to Q4 results in controlling power to the load 7. An output voltage detector 11a is connected to a first end of the secondary winding S1, to detect an output voltage V1 of the inverter 1c. An output voltage detector 11b is connected to a first end of the secondary winding S2, to detect an output voltage V2 of the inverter 1d.

An output voltage difference detector 13 detects a voltage difference between the output voltage V1 from the output voltage detector 11a and the output voltage V2 from the output voltage detector 11b. According to the voltage difference from the output voltage difference detector 13, a phase difference variable determiner 15 determines a phase difference variable. According to the phase difference variable from the phase difference variable determiner 15, the controller 10a changes a phase difference between drive signals to be sent to the two inverters 1c and 1d. Output currents are controlled according to the ON duties of the switches Q1 and Q3.

An example of changing a phase difference between the output voltages V1 and V2 will be explained. The triangular signal generated according to the related art illustrated in FIGS. 1 and 2 has the same rise time and fall time. The present invention changes the rise time and fall time of a triangular signal to produce a phase difference between drive signals.

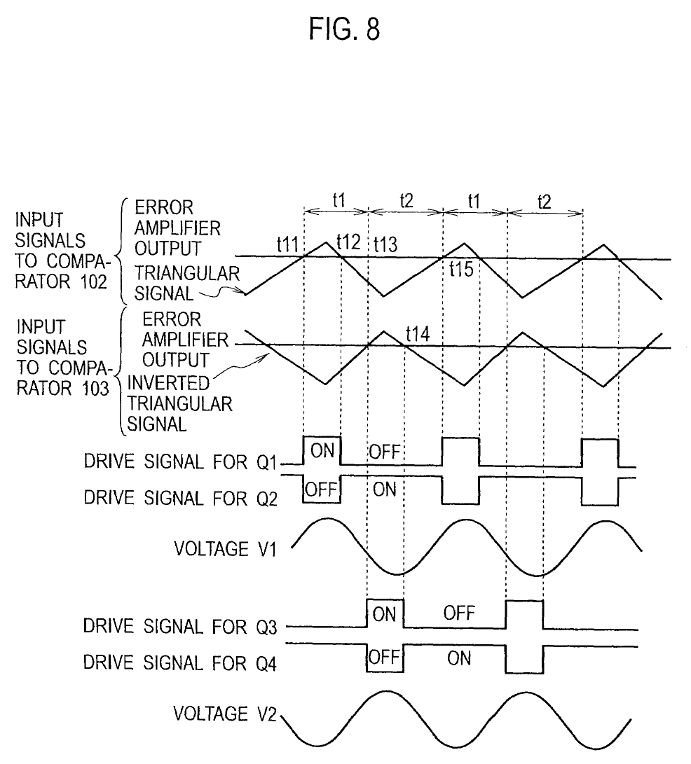

FIG. 8 is a timing chart illustrating a phase difference controlling operation achieved by the AC power source apparatus of FIG. 7 according to Embodiment 1. In FIG. 8, a triangular signal supplied to the comparator 102 has a longer rise time than a fall time. A period t1 is from time t11 at which a drive signal for the switch Q1 rises to time t13 at which a drive signal for the switch Q3 rises. A period t2 is from the time t13 to time t15 at which the drive signal for the switch Q1 rises. The period t1 is shorter than the period t2 (t1<t2).

If a phase difference between the drive signals to the two inverters 1c and 1d is just 180 degrees, the periods t1 and t2 are equal to each other (t1=t2). According to the example of FIG. 8, a phase difference between the drive signals to the inverters 1c and 1d is not 180 degrees but the phase of the inverter 1d is ahead of the phase of the inverter 1c. If the triangular signal has a shorter rise time than a fall time (t1>t2), the phase of the inverter 1d is behind the phase of the inverter 1c (not illustrated).

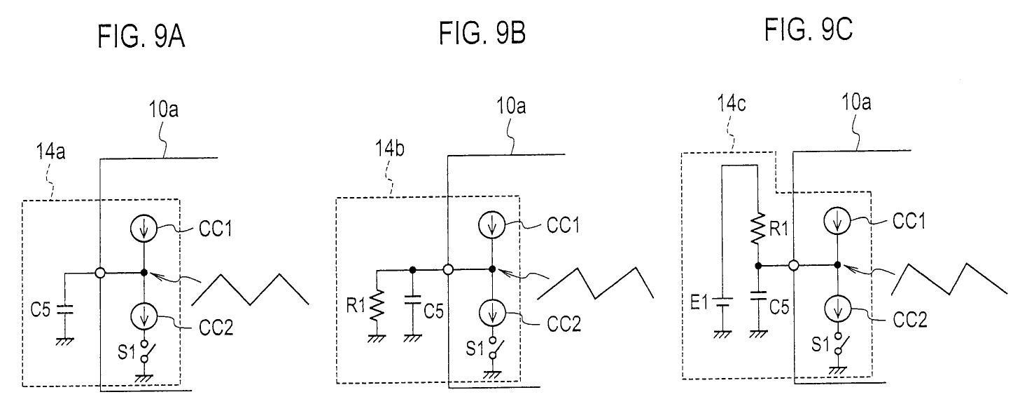

FIGS. 9A to 9C illustrate functions and triangular signals provided by the triangular signal generator arranged in the controller 10a of the AC power source apparatus according to Embodiment 1. Controlling the waveform of a triangular signal thereby controlling a phase difference between drive signals according to Embodiment 1 will be explained with reference to FIGS. 9A to 9C.

FIG. 9A illustrates a normal configuration of the triangular signal generator 14a in the controller 10a. Current sources CC1 and CC2 and a switch S1 are connected in series. Between a connection point of the current sources CC1 and CC2 and the ground, a capacitor C5 is connected. A current of the current source CC2 is twice as large as a current of the current source CC1. When the switch S1 is OFF, the current of the current source CC1 charges the capacitor C5. When the switch S1 is ON, the capacitor C5 discharges through the current source CC2 and switch S1. Consequently, the triangular signal generator 14a provides an oscillating triangular signal at ends of the capacitor C5. Switching the current sources CC1 and CC2 from one to another determines the rise time and fall time of the triangular signal and the triangular signal generator 14a is configured to equalize the rise time and fall time of the triangular signal.

FIG. 9B illustrates another configuration (14b) of the triangular signal generator 14 in the controller 10a. In addition to the configuration of FIG. 9A, the triangular signal generator 14b connects a resistor R1 in parallel with the capacitor C5. This elongates the charging time of the capacitor C5 and shortens the discharging time thereof. As results, the triangular signal generator 14b generates a triangular signal having a longer rise time than a fall time.

FIG. 9C illustrates still another configuration (14c) of the triangular signal generator 14 in the controller 10a. Compared with the configuration of FIG. 9A, the triangular signal generator 14c connects a first end (non-grounded side) of the capacitor C5 to a DC power source E1 through a resistor R1. This elongates the discharging time of the capacitor C5 and shortens the charging time thereof. As results, the triangular signal generator 14c generates a triangular signal having a longer fall time than a rise time.

In this way, the triangular signal generator 14 is switched among the circuit configurations 14a, 14b, and 14c as illustrated in FIGS. 9A, 9B, and 9C according to a voltage difference between the output voltages V1 and V2 of the two inverters 1c and 1d, to control a phase difference between the drive signals for the inverters 1c and 1d.

In this way, the waveform of the triangular signal is controllable by controlling the triangular signal generator 14 through the states 14a, 14b, and 14c illustrated in FIGS. 9A, 9B, and 9C.

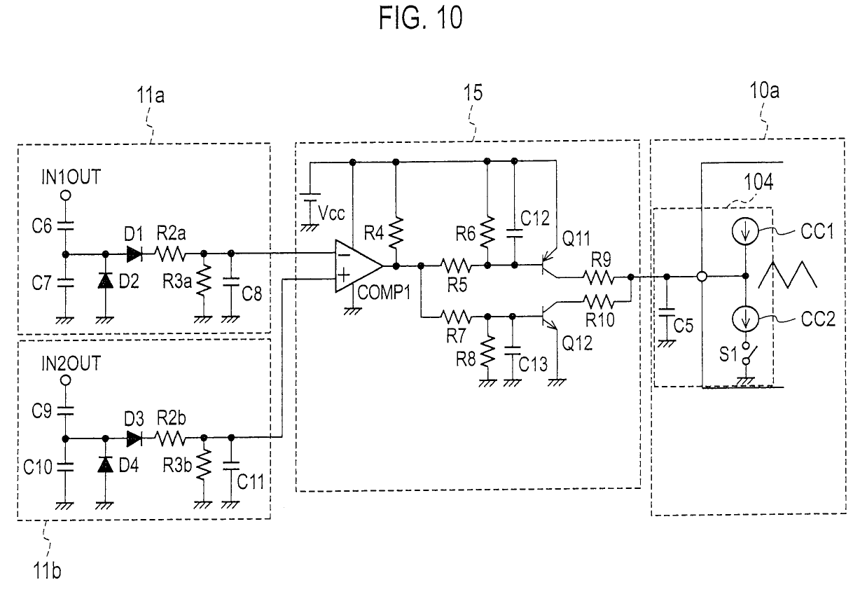

FIG. 10 is a circuit diagram illustrating the details of the output voltage detectors, output voltage difference detector, phase difference variable determiner, and controller of the AC power source apparatus according to Embodiment 1 illustrated in FIG. 7. The circuits illustrated in FIG. 10 control the waveform of a triangular signal.

In FIG. 10, the output voltage detector 11a includes a series circuit including capacitors C6 and C7 between the first end IN1OUT of the secondary winding S1 (FIG. 7) and the ground. A connection point of the capacitors C6 and C7 is connected to an anode of a diode D1 and a cathode of a diode D2. A cathode of the diode D1 is connected through a resistor R2a to an inverting input terminal (depicted by “−”) of a comparator COMP1. This inverting input terminal is also connected to a parallel circuit including a resistor R3a and a capacitor CB.

The output voltage detector 11b includes a series circuit including capacitors C9 and C10 between the first end IN2OUT of the secondary winding S2 (FIG. 7) and the ground. A connection point of the capacitors C9 and C10 is connected to an anode of a diode D3 and a cathode of a diode D4. A cathode of the diode D3 is connected through a resistor R2b to a non-inverting input terminal (depicted by “+”) of the comparator COMP1. This non-inverting input terminal is connected to a parallel circuit including a resistor R3b and a capacitor C11.

In the output voltage difference detector 13 and phase difference variable determiner 15, a power source Vcc supplies power to the comparator COMP1. A positive electrode of the power source Vcc is connected to a first end of a resistor R4, a first end of a resistor R6, a first end of a capacitor C12, and an emitter of a transistor Q11. An output terminal of the comparator COMP1 is connected to a second end of the resistor R4, a first end of a resistor R5, and a first end of a resistor R7. A second end of the resistor R5 is connected to a second end of the resistor R6, a second end of the capacitor C12, and a base of the transistor Q11. A second end of the resistor R7 is connected to a base of a transistor Q12 that is connected to a parallel circuit including a resistor R8 and a capacitor C13. An emitter of the transistor Q12 is grounded.

A collector of the transistor Q11 is connected through a resistor R9 to a first end of a capacitor C5 and a connection point of the current sources CC1 and CC2. The triangular signal generator 104 (corresponding to 14a to 14c in FIGS. 9A to 9C) in the controller 10a includes a series circuit including the current sources CC1 and CC2 and switch S1. The capacitor C5 is connected between a connection point of the current sources CC1 and CC2 and the ground.

Operation of the parts of the AC power source apparatus illustrated in FIG. 10 will be explained. In the output voltage detector 11a, the output voltage V1 of the inverter 1c (a voltage at the first end of the secondary winding S1) is divided by the capacitors C6 and C7 and is detected. The detected voltage is half-wave-rectified by the diode D1, is smoothed by the capacitor C8, and is supplied to the inverting input terminal of the comparator COMP1.

In the output voltage detector 11b, the output voltage V2 of the inverter 1d (a voltage at the first end of the secondary winding S2) is divided by the capacitors C9 and C10 and is detected. The detected voltage is half-wave-rectified by the diode D3, is smoothed by the capacitor C11, and is supplied to the non-inverting input terminal of the comparator COMP1.

If the output voltage V1 of the inverter 1c is smaller than the output voltage V2 of the inverter 1d, the comparator COMP1 provides a high-level output to turn on the transistor Q12 and off the transistor Q11. As results, the capacitor C5 and resistor R10 are connected in parallel with each other, to establish the state of the triangular signal generator 14b illustrated in FIG. 9B. This state generates a triangular signal having a longer rise time than a fall time.

When this action zeroes an output voltage difference between the output voltages V1 and V2, a difference between two inputs to the comparator COMP1 becomes zero.

The comparator COMP1 has a very large gain, and therefore, the comparator COMP1 alternately provides high-level and low-level outputs at predetermined intervals. Then, the transistors Q11 and Q12 are alternately turned on/off at the predetermined intervals. This causes a negative feedback operation to fix an average of currents flowing to or from the capacitor C5 of the controller 10a, thereby keeping a constant phase difference.

The above-mentioned operation is a D-class operation with the transistors Q11 and Q12 serving as switches. Instead, the capacity of each of the capacitors C12 and C13 connected to the bases of the transistors Q11 and Q12 may be increased to make the transistors Q11 and Q12 perform an analog operation (A-class operation). In this case, when an output voltage difference is zeroed, the collector-emitter voltage of each of the transistors Q11 and Q12 keeps a given saturated voltage to reach an equilibrium state.

Those result in fixing an average of currents flowing to and from the capacitor C5 connected to the controller 10a and keeping a constant phase difference. Any one of the above-mentioned techniques may be employed.

If the output voltage V1 of the inverter 1c is greater than the output voltage V2 of the inverter 1d, the comparator COMP1 provides a low-level output to turn on the transistor Q11 and off the transistor Q12. As a result, the capacitor C5 is connected through the resistor R9 to the power source Vcc, to establish the state of the triangular signal generator 14c illustrated in FIG. 9C. This state generates a triangular signal having a longer fall time than a rise time.

In this way, a voltage difference between the output voltages V1 and V2 of the two inverters 1c and 1d is used to change a phase difference between two drive signals around 180 degrees.

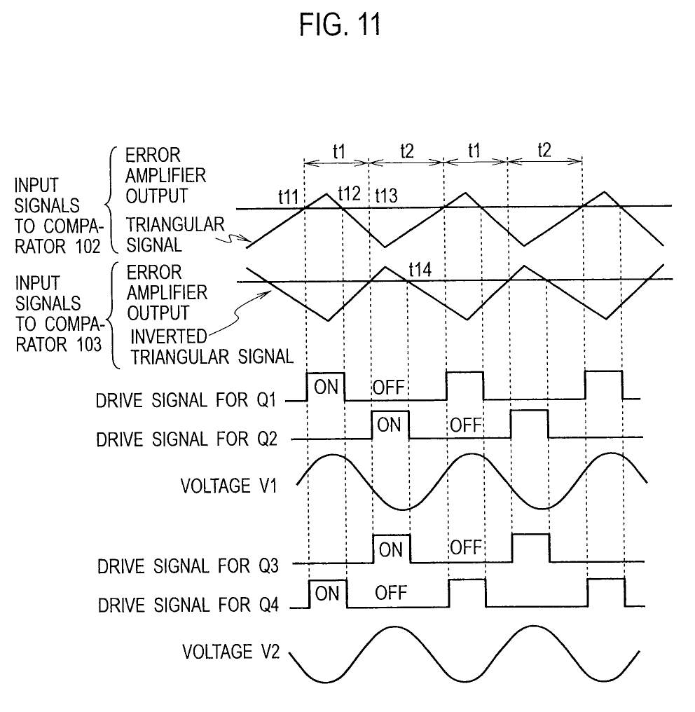

FIG. 11 is a timing chart illustrating operation of a modification of Embodiment 1. This modification is based on the circuit configuration illustrated in FIG. 7.

In FIG. 11, the comparator 102 generates drive signals for the switches Q1 and Q4 and the comparator 103 generates drive signals for the switches Q2 and Q3. The switches Q1 to Q4 have the same ON duty to control power. A phase difference between the switches Q1 and Q2 is approximately 180 degrees and a phase difference between the switches Q3 and Q4 is also approximately 180 degrees. Accordingly, each inverter can easily generate a sinusoidal voltage.

According to the AC power source apparatus of Embodiment 1 mentioned above, the controller 10a controls the ON duties of the switches Q1 to Q4, to control output power to the load 7. The phase difference variable determiner 15 controls a phase difference in such a way as to equalize the output voltages V1 and V2 of the inverters 1c and 1d. Namely, Embodiment 1 controls the ON duties of the switches Q1 and Q3 to control output power to the load 7 (7-1 to 7-n). If a voltage difference occurs between the output voltages of the two inverters, Embodiment 1 controls a phase difference between two drive signals in such a way as to minimize the voltage difference. The AC power source apparatus according to Embodiment 1 employs the single controller 10a to equalize the output voltages or output currents of the two inverters 1c and 1d without specially managing parts constants.

### Embodiment 2

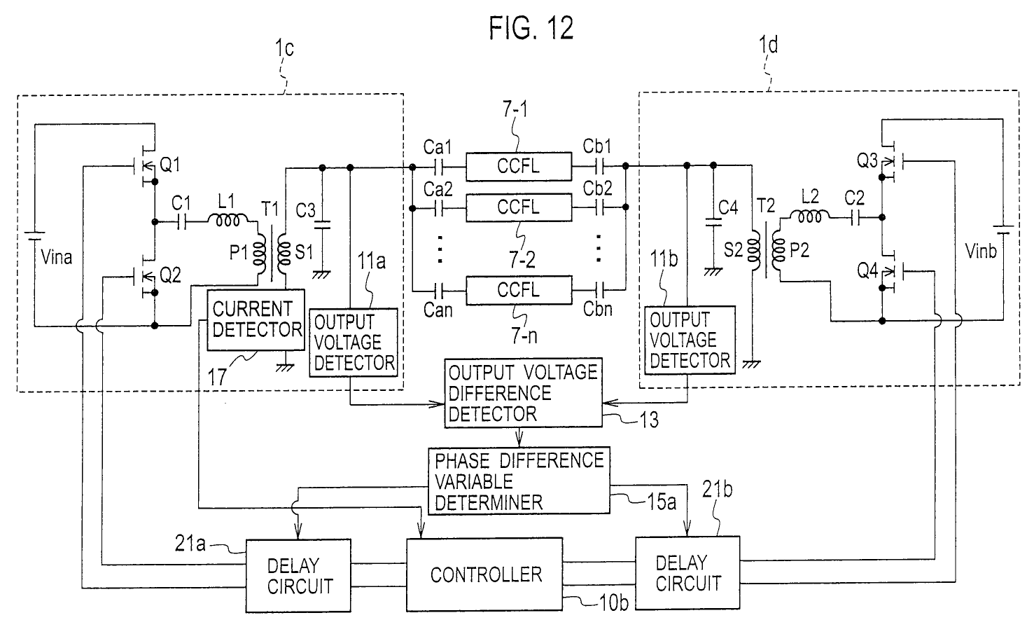

FIG. 12 is a circuit diagram illustrating an AC power source apparatus according to Embodiment 2 of the present invention. Embodiment 2 arranges a delay circuit 21a (first delay circuit) between a controller 10b and switches Q1 and Q2 and a delay circuit 21b (second delay circuit) between the controller 10b and switches Q3 and Q4.

The delay circuit 21a delays, according to a phase difference variable from a phase difference variable determiner 15a, drive signals Q1g and Q2g provided by the controller 10b and supplies the delayed drive signals to the switches Q1 and Q2. The delay circuit 21b delays, according to a phase difference variable from the phase difference variable determiner 15a, drive signals Q3g and Q4g provided by the controller 10b and supplies the delayed drive signals to the switches Q3 and Q4.

The remaining configuration of the AC power source apparatus of Embodiment 2 is the same as that of Embodiment 1 illustrated in FIG. 7.

According to the present embodiment, the controller 10b controls the ON duties of the switches Q1 to Q4 according to a current detected by a current detector 17, to thereby control output power.

An output voltage difference detector 13 detects an output voltage difference between two inverters 1c and 1d. According to the output voltage difference, the phase difference variable determiner 15a determines a phase difference variable that indicates one of the inverters 1c and 1d whose drive signals are going to be delayed and a delay amount. According to the determined phase difference variable, one of the delay circuits 21a and 21b is operated. The operated one of the delay circuits 21a and 21b delays drive signals provided by the controller 10b.

In this way, the delay circuits 21a and 21b control the phases of drive signals in such a way as to minimize the output voltage difference between the inverters 1c and 1d.

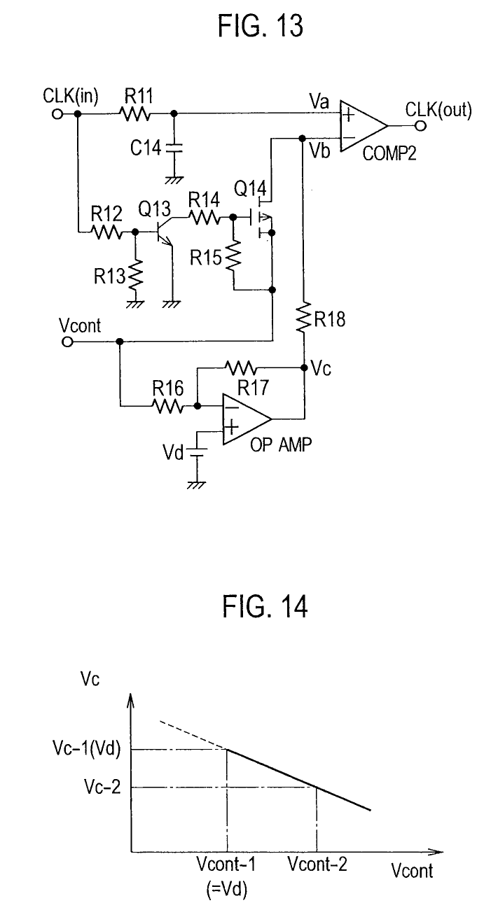

FIG. 13 is a circuit diagram illustrating the delay circuit (21a or 21b) in the AC power source apparatus according to the present embodiment. In FIG. 13, CLK(in) is a pulse signal provided by the controller 10b and Vcont is a signal voltage (DC voltage linearly changing in response to a phase difference variable) provided by the phase difference variable determiner 15a.

A terminal CLK is connected to a first end of a resistor R11 and a first end of a resistor R12. A second end of the resistor R11 is connected to a non-inverting input terminal (depicted by “+”) of a comparator COMP2 and a first end of a capacitor C14. A second end of the resistor R12 is connected to a base of a transistor Q13 and a first end of a resistor R13. An emitter of the transistor Q13 is grounded. A collector of the transistor Q13 is connected through a resistor R14 to a gate of a p-type MOSFET Q14 and a first end of a resistor R15. A second end of the resistor R15 is connected to a source of the MOSFET Q14 and a terminal Vcont. A drain of the MOSFET Q14 is connected to an inverting input terminal (depicted by “−”) of the comparator COMP2. The MOSFET Q14 is used as a signal ON/OFF switch.

The terminal Vcont is connected to a first end of a resistor R16. A second end of the resistor R16 is connected to an inverting input terminal (depicted by “−”) of an operational amplifier OPAMP. A non-inverting input terminal (depicted by “+”) of the operational amplifier OPAMP receives a voltage Vd. An output terminal of the operational amplifier OPAMP is connected to a second end of a resistor R17 and a first end of a resistor R18. A second end of the resistor R18 is connected to the inverting input terminal of the comparator COMP2. An output terminal of the comparator COMP2 is an output terminal CLK(OUT) of the delay circuit to output a delayed clock signal as a delayed signal.

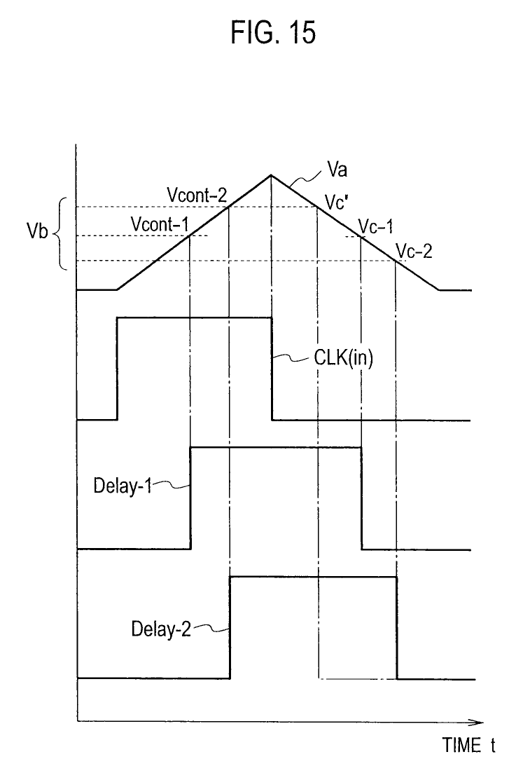

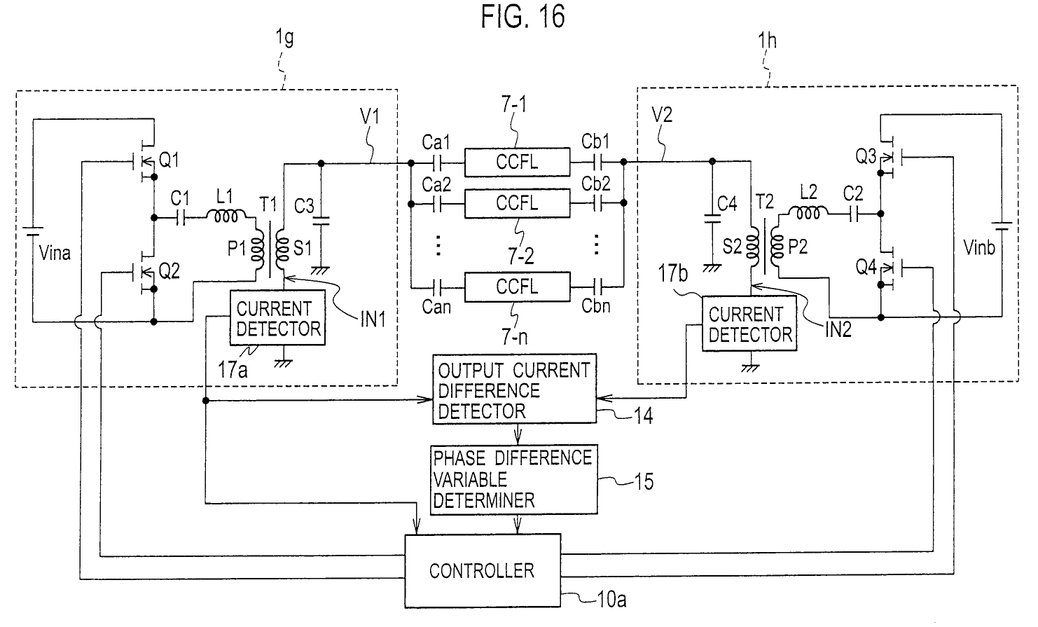

FIG. 14 is a graph illustrating a relationship between the signal voltage Vcont from the phase difference variable determiner 15a and an output Vc from the operational amplifier OPAMP in the delay circuit. FIG. 15 is a timing chart illustrating the clock signal and delayed signals in the delay circuit.

With reference to FIGS. 13 to 15, operation of the delay circuit will be explained. The clock pulse CLK(in) is integrated by the resistor R11 and capacitor C14. The integrated signal is supplied to the non-inverting input terminal of the comparator COMP2, which compares the integrated signal with a voltage Vb at the inverting input terminal thereof and delays the integrated signal, accordingly. The reference voltage Vb is variable to adjust a delay time.

During a period of receiving the clock pulse CLK(in), the transistors Q13 and Q14 are ON, and therefore, the voltage Vb becomes the voltage Vcont as illustrated in FIG. 15. When the clock pulse CLK(in) drops to 0 V, the transistors Q13 and Q14 turn off, and therefore, the voltage Vb becomes the output voltage Vc of the operational amplifier OPAMP serving as an inverting amplifier, as illustrated in FIG. 15.

The voltage Vc from the operational amplifier OPAMP is provided by amplifying a difference between the voltage Vcont and the reference voltage Vd and is proportional to the voltage Vcont in a negative correlation as illustrated in FIG. 14.

When generating a delay time for the delay circuit 21a to create a delayed signal Delay-1 and a delay time for the delay circuit 21b to create a delayed signal Delay-2, each delayed signal should be adjusted to a pulse width of the clock pulse CLK(in). As illustrated in FIG. 15, a delay time for a rise of a pulse of a delayed signal is adjustable according to the voltage Vcont. However, if a fall of the pulse of the delayed signal is determined by using the voltage Vcont as the voltage Vb, the pulse width of the delayed signal will be short.

Threshold values Vcont-1 and Vc-1 are set to the same voltage (Vd). However, a threshold value Vcont-2 is set to be higher than the threshold values Vcont-1 and Vc-1. Accordingly, the delayed signal Delay-1 will have the same pulse width as the clock pulse CLK(in). However, the delayed signal Delay-2 that is behind the delayed signal Delay-1 will have a shorter pulse width than the clock pulse CLK(in) if a fall of the delayed signal Delay-2 is determined according to the timing (Vc′) of the threshold Vcont-2.

To correctly adjust the pulse width of the delayed signal Delay-2 to that of the clock pulse CLK(in), the voltage Vb, i.e., the voltage Vc must be lowered to Vc-2 that is smaller than Vc-1. Thus, the inverting amplifier OPAMP having a predetermined offset voltage is employed to realize the characteristic (FIG. 14) of the voltage Vc that is proportional to the voltage Vcont with a negative inclination.

### Embodiment 3

FIG. 16 is a circuit diagram illustrating an AC power source apparatus according to Embodiment 3 of the present invention. Unlike Embodiment 1 of FIG. 7 that detects output voltages, finds a voltage difference between the output voltages, and controls the phases of drive signals according to the voltage difference, Embodiment 3 detects output currents, finds a current difference between the output currents, and controls the phases of drive signals according to the current difference.

Embodiment 3 of FIG. 16 differs from Embodiment 1 of FIG. 7 in that Embodiment 3 omits the output voltage detectors 11a and 11b and employs specific parts mentioned below.

According to the present embodiment illustrated in FIG. 16, an inverter 1g includes a current detector 17a (first current detector) that is connected in series with a secondary winding S1 of a transformer T1, to detect a first AC current passing through a first end of each of discharge lamps 7-1 to 7-n and output the detected first AC current to a controller 10a and an output current difference detector 14. Similarly, an inverter 1h includes a current detector 17b (second current detector) that is connected in series with a secondary winding S2 of a transformer T2, to detect a second AC current passing through a second end of each of the discharge lamps 7-1 to 7-n and output the detected second AC current to the output current difference detector 14.

The output current difference detector 14 detects a current difference between the first AC current from the current detector 17a and the second AC current from the current detector 17b. According to the current difference from the output current difference detector 14, a phase difference variable determiner 15 determines a phase difference variable. According to the phase difference variable from the phase difference variable determiner 15, the controller 10a controls a phase difference between drive signals for the inverters 1g and 1h.

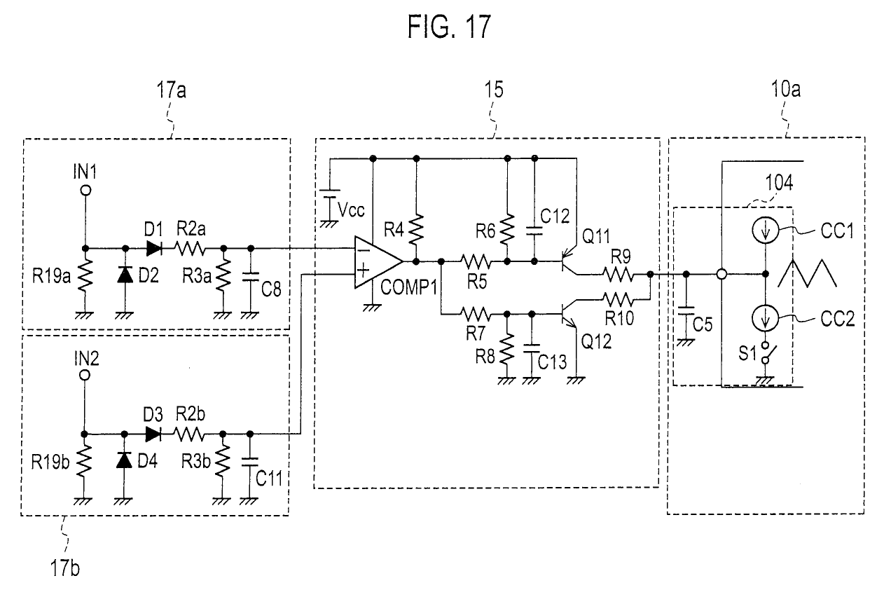

FIG. 17 is a circuit diagram illustrating the details of the output current detectors, output current difference detector, phase difference variable determiner, and controller of the AC power source apparatus according to the present embodiment of FIG. 16.

The part of Embodiment 3 illustrated in FIG. 17 differs from the part of Embodiment 1 illustrated in FIG. 10 in that Embodiment 3 has the output current detectors 17a and 17b instead of the output voltage detectors 11a and 11b of Embodiment 1, and therefore, only the difference will be explained.

The output current detector 17a of FIG. 17 differs from the output voltage detector 11a of FIG. 10 in that a resistor R19a is connected between a terminal IN1 and the ground and that a first end of the resistor R19a is connected to an anode of a diode D1 and a cathode of a diode D2.

In the output current detector 17a, an output current (first AC current) to the terminal IN1 is passed through the resistor R19a to the ground. The current is also passed through the diode D1 and resistors R2a and R3a to the ground. As a result, a voltage corresponding to the output current is applied to an inverting input terminal of a comparator COMP1.

In the output current detector 17b, an output current (second AC current) to a terminal IN2 is passed through a resistor R19b to the ground. The current is also passed through a diode D3 and resistors R2b and R3b to the ground. As results, a voltage corresponding to the output current is applied to a non-inverting input terminal of the comparator COMP1.

The output current difference detector 14, phase difference variable determiner 15, and controller 10a illustrated in FIG. 17 operate like those illustrated in FIG. 10. The present embodiment minimizes the current difference by controlling the phase of a current difference between drive signals. Consequently, the AC power source apparatus according to the present embodiment is capable of equalizing output currents of the two inverters with the use of the single controller without specially managing parts constants.

### Embodiment 4

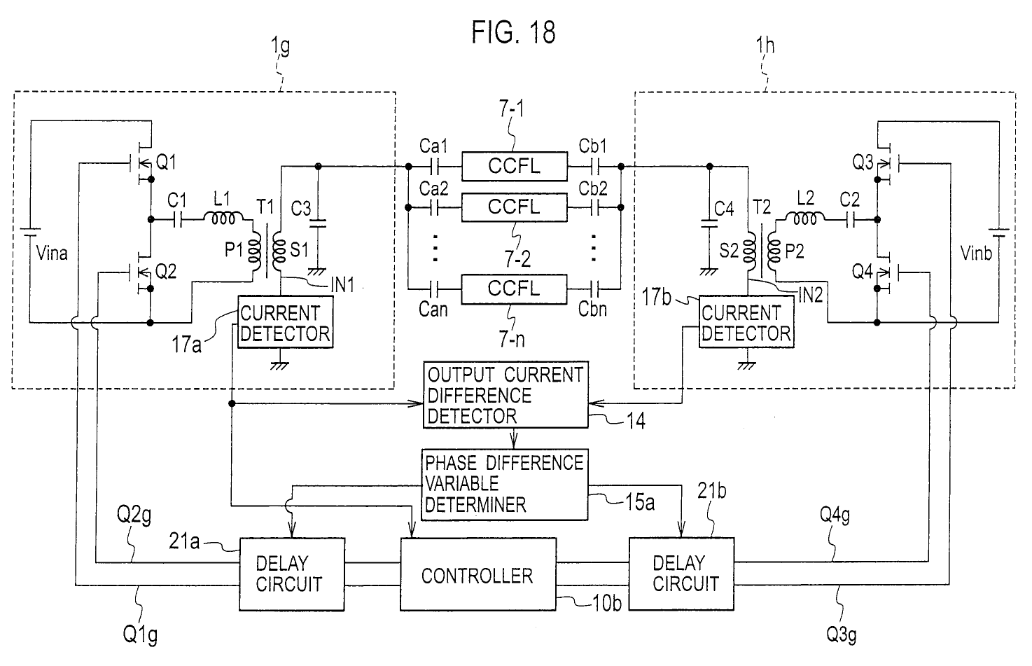

FIG. 18 is a circuit diagram illustrating an AC power source apparatus according to Embodiment 4 of the present invention. Embodiment 4 arranges a delay circuit 21a (first delay circuit) between a controller 10b and switches Q1 and Q2 and a delay circuit 21b (second delay circuit) between the controller 10b and switches Q3 and Q4.

The delay circuit 21a delays, according to a phase difference variable from a phase difference variable determiner 15a, drive signals Q1g and Q2g provided by the controller 10b and supplies the delayed drive signals to the switches Q1 and Q2, respectively. The delay circuit 21b delays, according to a phase difference variable from the phase difference variable determiner 15a, drive signals Q3g and Q4g provided by the controller 10b and supplies the delayed drive signals to the switches Q3 and Q4, respectively.

The remaining configuration of Embodiment 4 is the same as that of Embodiment 3 illustrated in FIG. 16.

Embodiment 4 is a combination of Embodiments 2 and 3, and therefore, provides the effects of Embodiments 2 and 3.

In summary, the AC power source apparatus according to any one of the embodiments of the present invention employs a controller to control the ON duty of a first switch unit to control first AC power and the ON duty of a second switch unit to control second AC power and a phase difference controller to control a phase difference in such a way as to equalize at least one of output voltage and output current in the output power of a first AC power generator with that of a second AC power generator. Namely, the apparatus controls the ON duties of the switch units, to control output power to a load. If a difference occurs in output voltage or output current between the two AC power generators (inverters), the apparatus controls a phase difference in such a way as to minimize the voltage or current difference. The apparatus equalizes the output voltages or currents of the two inverters with the use of the single controller without specially managing parts constants.

This application claims benefit of priority under 35USC §119 to Japanese Patent Application No. 2008-112889, filed on Apr. 23, 2008, the entire content of which is incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An AC power source apparatus comprising:
a first AC power generator having a first switch and configured to generate a first AC voltage from a DC voltage of a first DC power source by way of an ON/OFF operation of the first switch and output the first AC voltage to a first end of a load;
a second AC power generator having a second switch and configured to generate a second AC voltage from a DC voltage of one of the first DC power source and a second DC power source by way of an ON/OFF operation of the second switch and output the second AC voltage to a second end of the load, the second AC voltage having a phase difference of about 180 degrees with respect to the first AC voltage;
a controller configured to control an ON duty of the first switch thereby controlling first AC power, set a phase difference for the ON/OFF operation of the second switch with respect to that of the first switch, and control an ON duty of the second switch thereby controlling second AC power; and
a phase difference controller configured to control the phase difference set for the ON/OFF operation of the second switch so that output voltage or output current of the second AC power generator is equalized with that of the first AC power generator.

2. The AC power source apparatus of claim 1, wherein:
the phase difference controller includes:
a first voltage detector configured to detect the first AC voltage;
a second voltage detector configured to detect the second AC voltage;
a voltage difference detector configured to detect a voltage difference between the detected first and second AC voltages; and
a phase difference variable determiner configured to determine a phase difference variable according to the detected voltage difference; and
the controller controls the phase difference set for the ON/OFF operation of the second switch according to the determined phase difference variable.

3. The AC power source apparatus of claim 1, wherein the phase difference controller includes:
a first voltage detector configured to detect the first AC voltage;
a second voltage detector configured to detect the second AC voltage;
a voltage difference detector configured to detect a voltage difference between the detected first and second AC voltages;
a phase difference variable determiner configured to determine a phase difference variable according to the detected voltage difference;
a first delay circuit configured to delay, according to the determined phase difference variable, a first drive signal provided by the controller and supply the delayed first drive signal to the first switch; and
a second delay circuit configured to delay, according to the determined phase difference variable, a second drive signal provided by the controller and supply the delayed second drive signal to the second switch.

4. The AC power source apparatus of claim 1, wherein:
the phase difference controller includes:
a first current detector configured to detect a first AC current outputted to the first end of the load;
a second current detector configured to detect a second AC current outputted to the second end of the load;
a current difference detector configured to detect a current difference between the detected first and second AC currents; and
a phase difference variable determiner configured to determine a phase difference variable according to the detected current difference; and
the controller controls the phase difference set for the ON/OFF operation of the second switch according to the determined phase difference variable.

5. The AC power source apparatus of claim 1, wherein the phase difference controller includes:
a first current detector configured to detect the first AC current outputted to the first end of the load;
a second current detector configured to detect the second AC current outputted to the second end of the load;
a current difference detector configured to detect a current difference between the detected first and second AC currents;
a phase difference variable determiner configured to determine a phase difference variable according to the detected current difference;
a first delay circuit configured to delay, according to the determined phase difference variable, a first drive signal provided by the controller and supply the delayed first drive signal to the first switch; and
a second delay circuit configured to delay, according to the determined phase difference variable, a second drive signal provided by the controller and supply the delayed second drive signal to the second switch.
